(19) United States
(12) Patent Application Publication
(10) Pub. No.: US 2006/0175823 A1
(43) Pub. Date: Aug. 10, 2006

(54) Stick-it sheet paper organizer

(76) Inventor: Moti Shai, Calabasas, CA (US)

Correspondence Address: MOTI SHAI, 3528 VIADEL PRADO, CALABASAS, CA, 91302, US

(21) Appl. No.: 11/064,256

(22) Filed: Feb. 7, 2005

(51) Int. Cl. B42D 1/00

(52) U.S. Cl. 281/21.1

(57) ABSTRACT

A system and method for adding and removing paper sheets into organizers which include cover and sticky holders to hold the paper sheets inserted by the user. These organizers will come with predefined amount of sticky holders which are located in the middle of the organizer and it also allow the user to add more sticky holders if needed. Paper sheets in these organizers have clear view of the full page. The same method can be used for photo album, napkin or tissue binder, collection items binder, another embodiment. Pages that have sticky stripes are part of the page, so the user can organize ones own organizer and much more.

### BACKGROUND OF THE INVENTION

1. Field of the Invention

The present invention relates to sheets organizers which allow easy and convenient addition and removal of the sheets at any location inside the organizer which have no minimum thickness requirement and don't require any preparation to the paper sheet prior to be stored or remove.

2. Description of the Related Art

Most of the current organizers on today's marker generally include 2 types of paper sheet organizers and here are disadvantages of every one of them:

1. Binder (metal rings) based organizers:
a. It requires opening and closing the binder system in order to remove or add sheets of paper in a different location inside the organizer.
b. Minimum thickness is required in order to hold the binder system, the smallest one is about ¾ inch, which is a waste if you need to store only a few pages.
c. Predefined thickness size which forces the user to change the organizer in order to store more sheets when it full.
d. Requires preparation to the paper sheet, usually is punching holes in them and covering it with proper round stickers, in order to place it inside the organizer, stored paper sheets are warring off in the area of the hole very easily if the round sticker will not be used.
e. Relatively short life because the binder system is warring off after a few times of usage, usually binder rings are not attached to each other or over touching each other upon closure.
f. There is a minimum page size that these organizers can hold.
g. Binder system requires wide borders otherwise the hole area on the paper will be damaged any other solution will be more expensive.

2. Press based organizers:
a. It requires opening and closing the press plates in order to remove or add sheets of paper in a different location inside the organizer which requires organizing all the papers again prior to placing them back inside the organizer.
b. Minimum thickness is required in order to hold press plates system, the smallest one is about ¾ inch, which is a waste if you need to store only a few pages.
c. Stored paper requires wide borders otherwise certain area of the page will be covered.
d. Relatively expensive.

It is among the primary objects of the current invention to provide an improved sheets organizer which avoids or eliminates completely all disadvantages and other difficulties of existing organizers.

### SUMMARY OF THE INVENTION

In the embodiment of the current invention the organizer includes sticky holders to hold the paper sheets inserted by the user. These organizers will come with predefined amount of sticky holders which are located in the middle of the organizer and it also allow the user to add more sticky holders if needed. Paper sheets in these organizers have clear view of the full page.

To add a paper sheet the user requires to separate the sticky holder from its non sticky strip, then to flip over the page and place it on top of non sticky strip, while the page is properly aligned with other pages in the organizer, and then tight the sticky one on top of it by finger

To remove a paper sheet from the organizer the user just holds the page from the top or from the bottom of it and then lifts the page up.

Other objects, advantages and features of the present invention will become more apparent upon reading of the following non-restrictive description of preferred embodiments thereof, given by the way of example only with reference to the accompanying drawings.

### BRIEF DESCRIPTION OF THE DRAWINGS

The foregoing and other objects and advantages of the invention will be understood more fully from the following further description thereof, with reference to the accompanying drawings wherein:

FIG. 1 is a perspective view of the invention clearly showing the sticky holders.

FIG. 2 is a perspective view of the invention showing how pages are inserted and hold by sticky holders.

### DETAILED DESCRIPTION OF THE PREFERRED EMBODIMENTS

The present invention is directed to an improved system and method for providing easy, fast, convenient and efficient way of inserting paper sheets into organizers with no prior preparation. The preferred embodiments of the improved system and method are fully and detailed illustrated and described in the following paragraphs.

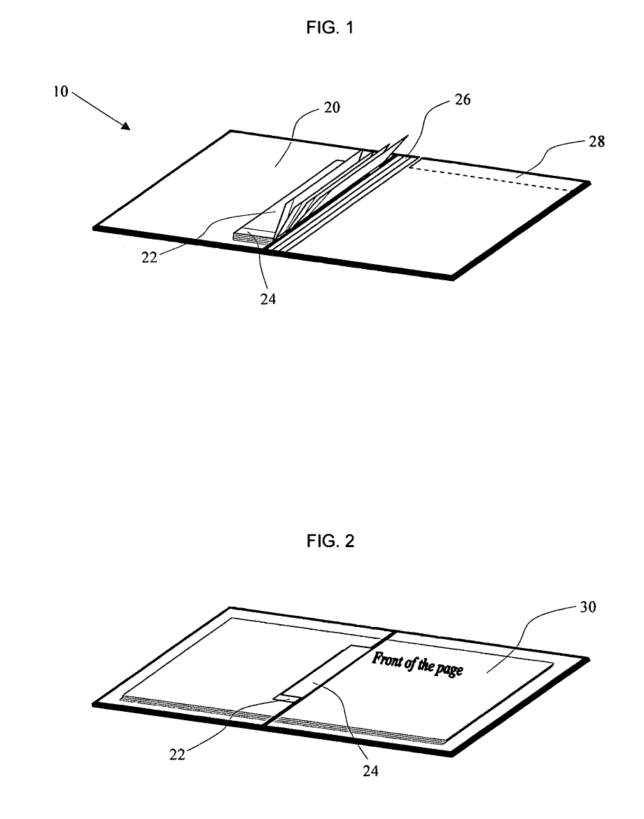

As illustrated in FIGS. 1 in a main embodiment with the present invention system 10 comprises the organizer cover 20, sticky holders 22 and the non sticky strip 24. Folding lines 26 provide different thickness ability of the organizer. Sheets guide 28 is part of the organized cover 20.

As illustrated in FIGS. 2 in a main embodiment with the present invention sticky holders 22 is attached to the back side of the page 30.

Referring to FIGS. 1 and 2 in a method for the use of a main embodiment in accordance with the present invention the system 10 enables to add and remove pages 30 in the following manner: first the user folds up the sheets guide 28 then user separates the sticky holder 22 from its non sticky strip 24, then the user flips over the page 30 and place it on top of non sticky strip 24, while the page 30 is attached to the sheets guide 28 and then the user tight the sticky one 22 on top of it by finger. To remove a paper sheet 30 from the organizer the user just holds the page 30 from the top or from the bottom of it and then lifts the page up.

In view of the above, it is apparent that the system and method of the preferred embodiments of the present invention enhance substantially reliability, practicality and effectiveness of enabling adding and removing paper sheets into organizers.

While the present invention has been described in connection with the specific embodiments identified herein, it will be apparent to those skilled in the art that many alternatives, modifications and variations are possible in light of the above description, like photo album, pages that sticky strip is part of it so the user can organizer his own folder just by sticking pages one of top of another, napkins or tissue with the sticky edge to be used in windy out doors and many more. Accordingly, the invention is intended to embrace all such alternatives, modifications and variations as may fall within the spirit and scope of the invention disclosed herein.

What is claimed is:

1. An improved system and method, providing a user organizer with sticky holders to hold the sheets, enabling fast and efficient was of inserting and removing sheets without any prior preparation, said device comprising:
a. a cover;
b. sticky holders;
c. thickness folding lines;
d. Foldable sheets guide.

2. The device of claim 1 wherein said sticky holders further comprises of sticky and non sticky stripes that said sheets will be placed between them.

3. The device of claim 2 wherein said sticky and not sticky stripes are different in their length for easy separation.

4. The device of claim 1 wherein said organizer with said sticky holders van be used as a photo album or collectable items.

5. An improved system and method of sheet paper with a sticky stripe as part of it folded and stack to the back of the sheet so the page can be used in its regular usage and then it can be organized by sticking it each to anther.

6. An improved system and method of napkin or tissue or the like with a sticky stripe as part of it so it can be used in windy outdoors or indoors in more organized manner.
